(19) United States
(12) Patent Application Publication
(10) Pub. No.: US 2009/0261063 A1
(43) Pub. Date: Oct. 22, 2009

(54) Method for Producing a Nanostructure on a Plastic Surface

(76) Inventors: Peter Munzert, Jena (DE); Michael Scheler, Jena (DE); Ulrike Schulz, Jena (DE); Norbert Kaiser, Jena (DE)

Correspondence Address: SLATER & MATSIL, L.L.P., 17950 PRESTON RD, SUITE 1000, DALLAS, TX, 75252-5793, US

(21) Appl. No.: 12/474,008

(22) Filed: May 28, 2009

Related U.S. Application Data
(63) Continuation of application No. PCT/DE2007/002151, filed on Nov. 28, 2007.

(30) Foreign Application Priority Data
Nov. 30, 2006 (DE) 10 2006 056 578.9

(51) Int. Cl. B44C 1/22

(52) U.S. Cl. 216/24; 216/67

(57) ABSTRACT

A nanostructure is produced at a surface of a substrate composed of a plastic by means of a plasma etching process. A thin layer is applied to the plastic substrate and the plasma etching process is subsequently carried out.

This application is a continuation of co-pending International Application No. PCT/DE2007/002151, filed Nov. 28, 2007, which designated the United States and was not published in English, and which claims priority to German Application No. 10 2006 056 578.9 filed Nov. 30, 2006, both of which applications are incorporated herein by reference.

### TECHNICAL FIELD

Embodiments of the invention relate to a method of producing a nanostructure on a plastic surface.

### BACKGROUND

The German patent publication DE 102 41 708 B4 (U.S. counterpart 2005/0233083) discloses a method for reducing the reflection of plastic substrates wherein a nanostructure is produced at a surface of a substrate composed of a plastic by means of a plasma etching process. In this case, the nanostructure is produced by bombarding the substrate surface with high-energy ions generated by means of a plasma ion source.

It has been found that the production of such a reflection-reducing nanostructure on some plastics is possible only with comparative difficulty, in particular, only with comparatively long etching times during the plasma etching process.

DE 102 41 708 B4 (US 2005/0233083) furthermore reveals that the duration of the plasma etching process should not be more than 300 s in the case of a substrate composed of PMMA, while for the polymer CR39, for example, a good antireflection effect is obtained given a treatment time of approximately 500 s. The differing treatment time for different plastic substrates makes it difficult to achieve the simultaneous antireflection configuration of plastic substrates composed of different materials in one work operation in the same vacuum chamber.

### SUMMARY

Embodiments of the invention specify an improved method for producing a nanostructure at a surface of a substrate composed of a plastic by means of a plasma etching process. In particular, the improved method is intended to make it possible to produce nanostructures with a comparatively low outlay on a large number of plastics, wherein the required treatment time when carrying out the plasma etching process in the case of different substrate materials advantageously does not differ significantly from one another.

In an embodiment according to the invention, a method for producing a nanostructure at a surface of a substrate composed of a plastic by means of a plasma etching process is disclosed. A thin layer is applied to the plastic substrate and the plasma etching process is subsequently carried out.

It has been found that nanostructures for reducing reflection can be produced by applying a thin layer before carrying out the plasma etching process including on plastic substrates for which this is possible only with difficulty, e.g., because comparatively long treatment times are necessary with a conventional plasma etching process. Furthermore, it has advantageously been found that the required treatment time for carrying out the plasma etching process is shortened in comparison with a conventional plasma etching process. A further advantage of the method is that the required duration of the plasma etching process in the case of substrates composed of different plastics advantageously differs from one another only insignificantly or not at all. This enables the simultaneous antireflection configuration of a plurality of plastic substrates composed of different plastics in one work operation in the same vacuum chamber.

The thin layer that is applied to the plastic substrate before the plasma etching process is carried out is preferably an oxide layer, a nitride layer or a fluoride layer. In particular, the thin layer can be a silicon oxide, silicon nitride, titanium oxide or magnesium fluoride layer.

The thickness of the thin layer is preferably 2 nm or less, particularly preferably 1.5 nm or less. In the context of the invention, the thickness of the thin layer should be understood to mean an average layer thickness if the thin layer is a non-continuous layer, in particular an insular layer.

The thin layer is preferably applied by means of a PVD (physical vapor deposition) method, in particular by means of sputtering or vacuum vapor deposition. By way of example, a dielectric oxide or nitride layer can be produced by reactive sputtering, in particular magnetron sputtering of a metallic target.

As an alternative to applying the thin layer by means of a vacuum coating method, the thin layer can also be produced on the surface of the plastic substrate by abrading a rubberlike layer, in a manner similar to that when a rubber eraser is abraded, or by applying and subsequently tearing off an adhesive tape.

The plasma etching process, which leads to the formation of the nanostructure having a reflection-reducing effect, is preferably carried out directly after the thin layer has been applied. The plasma etching process is advantageously carried out by means of a plasma containing oxygen. A suitable plasma etching process is known per se from the patent specification DE 102 41 708 B4 (US 2005/0233083), the disclosure content of which in this respect is hereby incorporated by reference.

The method according to an embodiment of the invention can be employed in the case of plastic substrates containing polycarbonate, a cycloolefin polymer, polyether sulfone, polyetherimide, polyamide, PET, PMMA or CR39.

A reduction of the required treatment time is obtained in this case in comparison with a conventional plasma etching process effected without the prior application of a thin layer. The duration of the plasma etching process is preferably 400 s or less, particularly preferably even 300 s or less.

In one preferred embodiment of the method according to an embodiment of the invention, the production of a nanostructure on a plurality of plastic substrates composed of different plastics is effected simultaneously. This is possible since the required treatment time for obtaining the best possible antireflection configuration in the case of different plastics does not differ, or differs only insignificantly, from one another.

The nanostructure produced by the method advantageously extends from the surface of the plastic substrate down to a depth of 50 nm or more into the plastic substrate. Particularly preferably, the depth of the nanostructure from the surface of the plastic substrate is between 50 nm and 200 nm inclusive.

In the method according to an embodiment of the invention, the plastic substrate can be an optical element or a transparent covering, in particular, for which the reflection of the surface is intended to be reduced. In a further preferred embodiment of the invention, the plastic substrate is a plastic film. It has been found that with the method, even comparatively large areas can be provided with a nanostructure, in particular areas having a size of 50 cm×50 cm or more. Therefore, large-area films can also be provided with a nanostructure.

The reflection of the surface of the plastic substrate is preferably reduced by the nanostructure produced by the method.

In one preferred embodiment of the method according to the invention, a transparent protective layer is applied to the nanostructure. The transparent protective layer protects the nanostructure produced against external influences, in particular against mechanical damage, which might occur, for example, during cleaning of the surface.

The thickness of the transparent protective layer is preferably chosen in such a way that, on the one hand, the nanostructure is sufficiently protected against external influences, but on the other hand the reflection-reducing effect is not lost. Particularly preferably, the thickness of the transparent protective layer is between 10 nm and 50 nm inclusive.

A silicon oxide, in particular SiO₂, is particularly suitable for forming a transparent protective layer.

### BRIEF DESCRIPTION OF THE DRAWINGS

The invention is explained in more detail below on the basis of exemplary embodiments in conjunction with FIGS. 1 to 4, in which:

FIGS. 1A-1C, collectively FIG. 1, show a schematic graphical illustration of an exemplary embodiment of the method according to the invention on the basis of intermediate steps;

FIG. 2 shows a schematic graphical illustration of a further method step in an exemplary embodiment of the method according to the invention;

FIG. 3 shows the transmission as a function of the wavelength in the case of a plastic substrate composed of Zeonex® treated by a method according to the invention in comparison with an untreated plastic substrate composed of Zeonex®; and

FIG. 4 shows the transmission as a function of the wavelength in the case of a plastic substrate composed of Ultrason® treated by a method according to the invention in comparison with an untreated plastic substrate composed of Ultrason®.

Identical or identically acting elements are provided with the same reference symbols in the figures. The figures should not be regarded as true to scale; rather, individual elements may be illustrated with an exaggerated size for clarification purposes.

### DETAILED DESCRIPTION

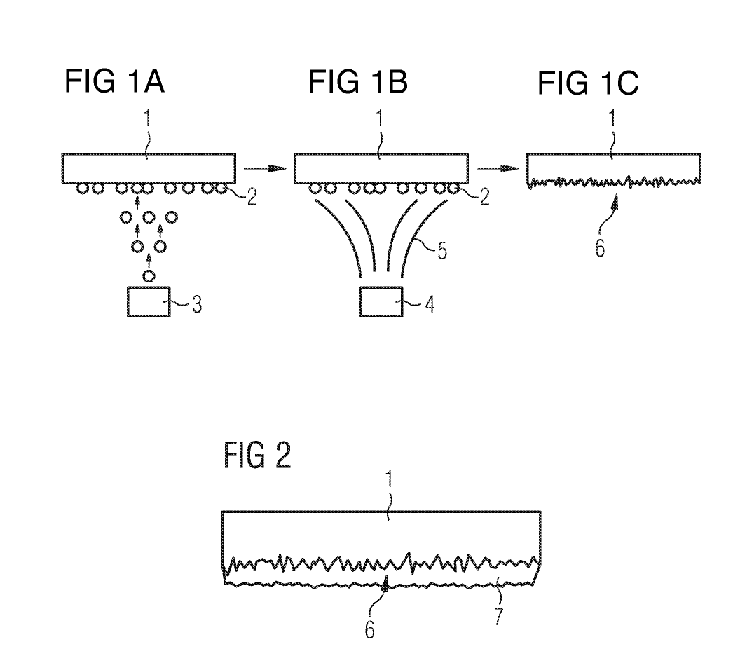

As illustrated in FIG. 1A, in a first intermediate step of a method according to the invention, a thin layer 2 is applied to a plastic substrate 1. The plastic substrate preferably comprises polycarbonate, a cycloolefin polymer, polyether sulfone, polyetherimide, polyamide, PET, PMMA or CR39. In particular the plastics from the group of cycloolefin polymers, polyether sulfones, polyetherimides or polyamides can be provided with a reflection-reducing nanostructure with comparative short etching times by means of the method according to an embodiment of the invention in comparison with a conventional plasma etching method. However, a shortening of the process duration by comparison with a conventional plasma etching method is advantageously also obtained in the case of plastics such as PMMA or CR39.

The thin layer 2 which is applied to the plastic substrate 1 is preferably an oxide layer, a nitride layer or a fluoride layer. In particular, thin layers composed of TiO₂, SiO₂, MgF₂ or composed of a silicon nitride are suitable.

The thin layer 2 is preferably an insular layer, that is to say a layer whose growth was interrupted in the initial stage in such a way that the layer has not yet grown together to form a continuous layer.

The thin layer 2 preferably has a thickness of 2 nm or less, particularly preferably of 1.5 nm or less. In this case, since the thin layer 2 can be an insular layer, in particular, the thickness of the thin layer 2 is understood to mean a thickness averaged over the surface of the plastic substrate 1. The average thickness of the thin layer 2 can be determined during growth, for example, by means of a calibrated quartz oscillator measurement system, the average layer thickness being calculated from the mass applied to the substrate. The average thickness of the insular thin layer corresponds to the thickness of a closed layer of uniform thickness that has the same mass as the insular layer actually applied.

The thin layer 2 is applied to the plastic substrate 1, for example, by vacuum vapor deposition from an evaporation source 3. In particular, the evaporation source 3 can be an electron beam evaporation source or a thermal evaporation source. As an alternative, other PVD methods can also be used for applying the thin layer 2. In particular, application by sputtering, for example, by reactive magnetron sputtering, is suitable. Applying the thin layer 2 by means of sputtering has the advantage that even comparatively large areas of a plastic substrate 1 can be coated homogeneously with the thin layer 2. By way of example, it is possible to coat even relatively large plastic substrates having a size of, for example, 50 cm×50 cm or more.

After the thin layer 2 has been applied to the plastic substrate 1, a plasma etching process is carried out for producing a nanostructure at the surface of the plastic substrate 1 as shown in FIG. 1B. A plasma ion source 4, for example, is used for generating the plasma. In particular, the plasma can be an argon plasma to which oxygen is fed. In the plasma 5, high-energy ions are accelerated toward the substrate and produce the nanostructure in this way. A suitable plasma ion source 4 and operating parameters suitable for carrying out the plasma etching process are known, for example, from the German publication DE 102 41 708 B4 (US 2005/0233083) and are therefore not explained in any greater detail here. Instead of this plasma ion source which is described in the prior art and which is typically used in vacuum vapor deposition systems for thermal and/or electron beam evaporation, the plasma etching process can also be carried out using other plasma sources. By way of example, a radiofrequency plasma source, which can be arranged as an etching station in a sputtering system, is also suitable.

It has advantageously been found that the required duration of the plasma etching process is advantageously shortened by the prior application of the thin layer 2 in comparison with the method described in the abovementioned document. In particular, the duration of the plasma etching process can be 400 s or less, preferably 300 s or less. The duration of the etching process can be optimized on the basis of measurements of the spectral transmission of samples treated with different etching times. In the case of an excessively short etching time, the reflection minimum can be undesirably shifted toward a shorter wavelength, while in the case of excessively long etching times, scattered light losses occur in the nanostructure.

Referring to FIG. 1C, the nanostructure 6 is produced at the surface of the plastic substrate 1 by means of the plasma etching process. The thin layer 2 applied previously can be wholly or partly removed from the surface of the plastic substrate 1 during the plasma etching process. The nanostructure 6 preferably extends from the surface of the plastic substrate 1 down to a depth of more than 50 nm into the substrate. Particularly preferably, the nanostructure 6 even extends down to a depth of 100 nm or more into the substrate. In a lateral direction, the structure sizes of the nanostructure 6 are preferably 70 nm or less, that is to say that a comparatively high aspect ratio is obtained.

In one preferred embodiment of the invention, as is illustrated in FIG. 2, after the nanostructure 6 has been produced at the surface of the plastic substrate 1, a transparent protective layer 7 is applied to the nanostructure 6. The transparent protective layer 7 protects the nanostructure 6 against external influences, in particular against mechanical damage. In particular, this reduces the risk of the nanostructure being damaged during cleaning of the surface of the plastic substrate 1.

It has been established that the transparent protective layer 7 emulates the nanostructure 6 only in the case of very small layer thicknesses of less than 10 nm. In the case of larger layer thicknesses, a closed layer forms which sufficiently protects the nanostructure 6 against mechanical damage, e.g., when the surface is wiped. In this case, the reflection-reducing effect of the nanostructure 6 produced is not impaired, or impaired only insignificantly, by the thin transparent layer if the layer thickness does not exceed 50 nm, particularly preferably 40 nm. Therefore, the transparent protective layer 7 preferably has a thickness of between 10 nm and 50 nm inclusive.

In order not to impair the reflection-reducing effect of the nanostructure 6, it is furthermore advantageous if the transparent protective layer 7 has a low refractive index. The transparent protective layer 7 is preferably an SiO₂ layer.

If a transparent protective layer 7 is applied to the nanostructure 6, it is advantageous if the duration of the previous etching process is chosen to be shorter than in the method without subsequent application of a protective layer. The duration of the etching process in this embodiment of the invention is preferably 200 s or less.

On account of the reflection-reducing effect of the nanostructure 6, the method according to an embodiment of the invention is suitable in particular for plastic substrates 1 for which reflection of incident radiation is undesirable, for example, in the case of transparent coverings of displays or in the case of optical elements.

In particular, embodiments can also be used for large-area plastic substrates 1, for example, for large-area coverings of optical display elements or for antireflection configuration of plastic films.

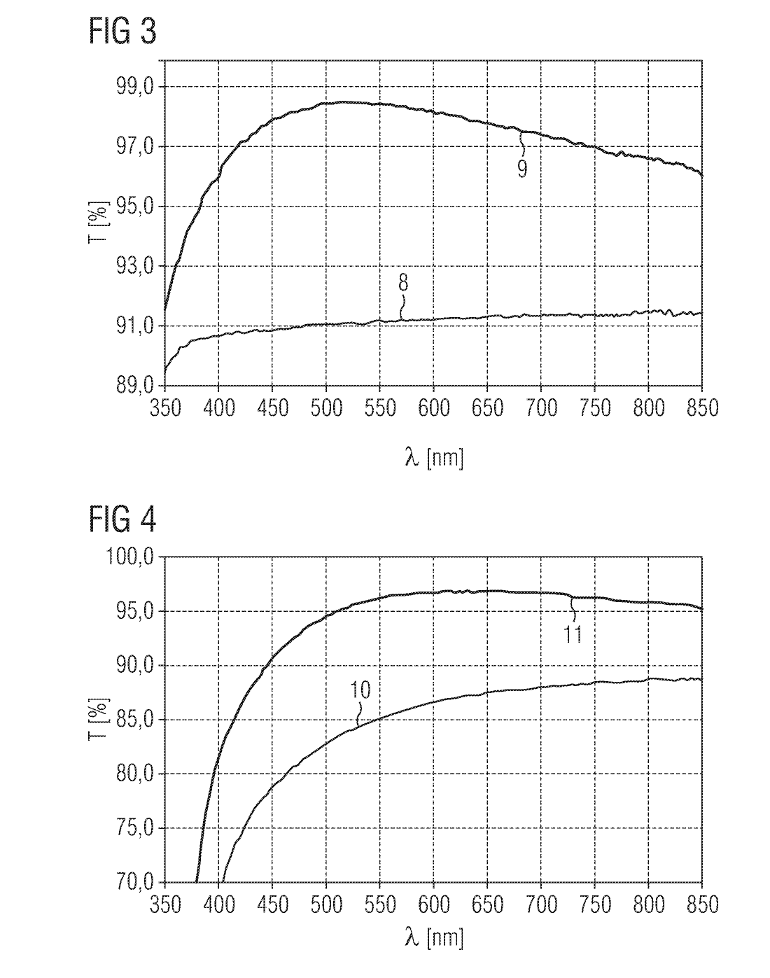

FIG. 3 illustrates the measured transmission of a plastic substrate composed of Zeonex® treated on both sides by the method according to an embodiment of the invention (curve 9) in comparison with an untreated Zeonex® substrate (curve 8). The measurement curves 8, 9 make it clear that, in particular, the transmission in the visible spectral range can be considerably improved by the production of nanostructures at both opposite surfaces of the plastic substrate by means of the method according to an embodiment of the invention.

The plastic substrate composed of Zeonex® used in this example embodiment is distinguished by a comparatively good dimensional stability under heat, for example, in comparison with PMMA, and can be used in particular up to a temperature of approximately 125° C. The transmission measurement illustrated (curve 9) was carried out on a sample having a diameter of 55 mm and a thickness of 1 mm, which was provided with a nanostructure on both sides by means of the method described herein. In order to produce the nanostructure, a thin TiO₂ layer was deposited onto the plastic substrate by means of electron beam evaporation in a vacuum vapor deposition system APS904 (Leybold Optics). This can be effected, for example, at a process pressure of approximately 1×10⁻⁵ mbar. The TiO₂ layer was deposited with a thickness of approximately 1.25 nm at a vapor deposition rate of 0.03 nm/s, in which case the layer thickness was detected during growth by means of a calibrated quartz oscillator measurement system. The thin layer was grown onto an untreated substrate; in particular, no plasma pretreatment was carried out before the growth of the thin layer.

The production of the nanostructure by means of a plasma etching process was effected without an intervening interruption of the vacuum cycle by means of a plasma ion source incorporated into the vacuum vapor deposition system. In order to carry out the etching process, argon at a flow rate of 14 sccm and oxygen at a flow rate of 30 sccm were admitted into the vacuum chamber. The plasma ion source was operated with a BIAS voltage, which is a measure of the energy of the Ar ions impinging on the substrate carrier, of 120 V and a discharge current of 50 A. The etching process was carried out with these process parameters with a duration of 300 s. It has been found that in the case of longer etching times, scattered light losses occur in the sample provided with the nanostructure, while in the case of shorter etching times, the best possible reflection reduction is not yet obtained in the visible spectral range.

FIG. 4 illustrates the measured transmission as a function of the wavelength for an untreated plastic substrate composed of the polyether sulfone Ultrason® E2010 (curve 10) and a plastic substrate composed of the polyether sulfone Ultrason® E2010 treated by the method according to an embodiment of the invention (curve 11). The polymer is a thermoplastic having a comparatively high dimensional stability under heat right into a temperature range of more than 200° C. It is distinguished by a comparatively high refractive index of n=1.65, which is advantageous for many optical applications, but can lead to disadvantageously high reflection losses at an interface with air.

The measured transmission curves 10 and 11 make it clear that the transmission of the 1.5 mm thick sample composed of Ultrason® used in the exemplary embodiment was able to be increased particularly in the visible spectral range as a result of the treatment by means of the method according to an embodiment of the invention, in which case an increase in the transmission of more than 10% was obtained, for example, at a wavelength of 550 nm.

In order to produce the sample, a silicon nitride layer having a thickness of approximately 1 nm was deposited onto the plastic substrate. The thin silicon nitride layer was deposited in a magnetron sputtering system by reactive DC sputtering at a power of 300 W in an Ar/N₂ plasma from an Si target, wherein argon at a flow rate of 10 sccm and nitrogen at a flow rate of 15 sccm were admitted into the vacuum chamber.

The nanostructure was produced by means of an etching process which was carried out without prior interruption of the vacuum cycle in an etching station of the sputtering system. The etching was effected in an argon/oxygen plasma. In this case, a radio frequency plasma having a frequency of 13.56 MHz and a plasma power of 100 W was used, wherein argon at a flow rate of 10 sccm and oxygen at a flow rate of 20 sccm were introduced into the vacuum chamber. As in the exemplary embodiment illustrated above, it has been found that the etching time for obtaining the best possible reflection reduction is approximately 300 s.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

What is claimed is:

1. A method for producing a nanostructure at a surface of a substrate composed of a plastic by means of a plasma etching process, the method comprising:
applying a thin layer having an average thickness of 2 nm or less to the substrate; and
subsequently carrying out a plasma etching process.

2. The method as claimed in claim 1, wherein the thin layer comprises an oxide layer, a nitride layer or a fluoride layer.

3. The method as claimed in claim 2, wherein the thin layer comprises silicon oxide, silicon nitride, titanium oxide or magnesium fluoride.

4. The method as claimed in claim 1, wherein applying the thin layer comprises sputtering or vacuum vapor deposition.

5. The method as claimed in claim 1, wherein applying the thin layer comprises abrading a rubberlike layer or applying and tearing off an adhesive tape.

6. The method as claimed in claim 1, wherein the thin layer comprises an insular layer.

7. The method as claimed in claim 1, wherein the substrate comprises a polycarbonate, a cycloolefin polymer, a polyether sulfone, a polyetherimide, a polyamide, PET, PMMA or CR39.

8. The method as claimed in claim 1, wherein the plasma etching process is carried out for 400 s or less.

9. The method as claimed in claim 1, wherein producing a nanostructure comprises producing a nanostructure on a plurality of substrates composed of different plastics simultaneously in a same vacuum chamber.

10. The method as claimed in claim 1, wherein the nanostructure extends from the surface of the substrate down to a depth of 50 nm or more into the substrate.

11. The method as claimed in claim 10, wherein the nanostructure extends from the surface of the substrate down to a depth of between 50 nm and 200 nm into the substrate.

12. The method as claimed in claim 1, wherein the substrate is an optical element.

13. The method as claimed in claim 1, wherein the substrate is a transparent covering of an optical display device.

14. The method as claimed in claim 1, wherein the substrate is a plastic film.

15. The method as claimed in claim 1, wherein the nanostructure reduces reflection of the substrate.

16. The method as claimed in claim 1, further comprising applying a transparent protective layer to the nanostructure.

17. The method as claimed in claim 16, wherein the transparent protective layer has a thickness of between 10 nm and 50 nm inclusive.

18. The method as claimed in claim 16, wherein the transparent protective layer comprises an SiO₂ layer.

19. The method as claimed in claim 16, wherein the plasma etching process is carried out for 200 s or less.
